(19) United States
(12) Patent Application Publication
(10) Pub. No.: US 2024/0017440 A1
(43) Pub. Date: Jan. 18, 2024

(54) METHOD AND DEVICE FOR PRODUCING WOOD SHAVINGS

(71) Applicant: SWISS KRONO TEC AG, Luzern (CH)

(72) Inventor: Martin Langhardt, Schüpfheim (CH)

(73) Assignee: SWISS KRONO TEC AG, Luzern (CH)

(21) Appl. No.: 18/032,646

(22) PCT Filed: Oct. 5, 2021
(86) PCT No.: PCT/EP2021/077467

§ 371 Date: Apr. 19, 2023

(30) Foreign Application Priority Data
Oct. 19, 2020 (EP) 20202644.9

(51) Int. Cl. B27L 11/00

(52) U.S. Cl. CPC B27L 11/002

(57) ABSTRACT

A method for producing wood chips for the production of chipboards includes
a material supply unit in at least one first carrying structure,
a first mechanical sorting unit for the material to be comminuted in at least one second carrying structure,
a material comminuting unit in at least one third carrying structure,
a second mechanical sorting unit for the comminuted material in at least one fourth carrying structure, and
   wherein the first, second, third, and fourth carrying structures are each arranged to be semi-mobile on a foundation and/or on a supporting structure and interconnected, wherein the supplied material is conveyed from the material supply unit through a first material-carrying line to the first mechanical sorting unit and is sorted from the first mechanical sorting unit through a second material-carrying line to the material comminution unit and is comminuted to form wood chips, and is supplied through a third material-carrying line to the second mechanical sorting unit.

### BACKGROUND OF THE INVENTION

The invention relates to a method and a device for producing wood chips for the production of chipboards.

The majority of wood chips are produced industrially from unprocessed or, alternatively, untreated wood and are used for the production of wood-based materials. For this purpose, high-output devices are setup in a stationary manner, usually in halls or shelters.

If smaller amounts of another wood-based material, for example recycling wood, are to be processed into wood chips, the other wood-based material is added to the unprocessed or untreated raw material in order to produce the chips. It is obvious that this method, in which different material must be processed in a disorganized manner, is not well controllable.

### SUMMARY OF THE INVENTION

The object of the invention is therefore to provide a method and a device that allow for improved provision of wood chips.

The object is achieved with a method and a device as disclosed herein.

The method according to the invention for producing wood chips for the production of chipboards, in particular made from recycling wood, comprises the following elements or steps:
a material supply unit in at least one first carrying structure,
a first mechanical sorting unit for the material to be comminuted in at least a second carrying structure,
a material comminuting unit in at least one third carrying structure, and
a second mechanical sorting unit for the comminuted material in at least one fourth carrying structure,
   wherein the first, second, third, and fourth carrying structures are each arranged so as to be semi-mobile on a foundation and/or on a supporting structure and are interconnected either directly or via material-carrying lines, wherein the supplied material is conveyed from the material supply unit through a first material-carrying line to the first mechanical sorting unit and is sorted, and is supplied from the first mechanical sorting unit through a second material-carrying line to the material comminution unit and is comminuted therein so as to form wood chips, and is supplied from there through a third material-carrying line to the second mechanical sorting unit, in which the wood chips are sorted by machine, whereupon the wood chips are provided for the production of chipboards. According to the invention, the first and second sorting takes place by machine.

The selection of units for the material supply unit, sorting unit, and comminution unit of such a size that they can be mounted in a carrying structure is an element of the invention. Units of this kind are available. However, they are units which are typically mounted in halls or buildings on fixed foundations, i.e. which are therefore immobile. According to the invention, they can be adapted for installation in a carrying structure by adapting the attachment points, for example.

The mounting of the units and, if applicable, of the control unit in a carrying structure is a further, essential element of the invention. Therefore, according to a preferred embodiment, beams, in most cases beams made of metal, e.g. double T-beams made of steel, are joined to form a carrying structure which is adapted to the respective unit, the weight thereof, and the weight distribution thereof as well as particularities, e.g. during operation, for example the vibrational behavior. If necessary, the carrying structure is reinforced by steel profiles or steel plates inserted in sections or completely between the beams, in particular at the contact or attachment points of the units and/or in the region of connections for handling the carrying structure as well as in the region of connections for fastening the carrying structures to means of transportation. The steel profiles or steel plates are preferably welded to the beams, but they may also be releasably or unreleasably connected to the beams in another way, for example by means of rivets, bolts, or screws. As a result, the carrying structure is optimally designed for securing or rather fastening the unit to the carrying structure.

Said carrying structure, in which the respective unit is then inserted, is preferably clad at least in sections with walls on the floor, sides, and ceiling so as to form a container. If necessary, a wall may, for example, be partially or fully absent if a unit cannot be fully accommodated in a container. Where the term “container” is used in connection with the present invention, a carrying structure that is clad at least in sections with a floor, walls, and/or ceiling is substantially meant. Connections for handling the container may also be attached at locations where the center of gravity of the respective container allows it, such that the container with the respective unit mounted therein can be handled safely. For other units which do not impose any special requirements on the containers, commercially available, prefabricated containers, for example shipping containers, may for example also be used, for example for accommodating the control unit.

If it is necessary to arrange a container above ground level without it being placed on another carrying structure or other container, it is recommended to arrange the container on a simple carrying structure, referred to in connection with this invention as a supporting structure, wherein the supporting structure does not contain any unit but rather consists solely of interconnected beams.

The supporting structure preferably has the same length and width as the carrying structure used for the device or, alternatively, the same length and width as containers containing units. The height of the supporting structure can preferably be individually adapted, such that the different supporting or carrying structures or, alternatively, containers can be set up at an optimal height relative to one another. Advantageously, the same fastening and carrier devices are used for the supporting structure as comprised by the carrying structures or, alternatively, containers with units. Preferably, the connections already comprised by the carrying structure or, alternatively, containers for handling and transportation can be used to secure the carrying structure or, alternatively, container containing a unit to the supporting structure, which contains no unit. If necessary, further connections may be provided for securing the carrying structure or, alternatively, container with a unit to the supporting structure without a unit. Releasable connections, e.g. screw or plug-in or rather form-fitting connections are preferred.

According to the invention, units such as a material supply unit, first and second sorting units, a material comminution unit, a material separation unit, and a buffer unit are arranged in a carrying structure. Carrying structures that are transportable are particularly preferable. Typical carrying structures in the context of the invention correspond in size to commercially available 20-foot or 40-foot containers, for example, which can be transported on means of transportation such as trucks or trains. Preferably, for this purpose, the carrying structures are provided with connections which allow for handling of the carrying structures as well as fastening of the carrying structures on means of transportation. However, since the units required for producing wood chips are heavy and often have an uneven weight distribution, typical shipping containers are generally not well suited, and instead, according to the invention, the above-described carrying structures that are individualized to the respective unit are used.

The units used for carrying out the method may, on the one hand, be received completely in a carrying structure. A typical unit that can be accommodated in a carrying structure is the material supply unit. Alternatively, a unit may also be divided into segments and accommodated in two or more carrying structures. Typically, this applies to the sorting unit, which, in a simple embodiment, may also be accommodated in one carrying structure. However, both the first and the second sorting unit preferably are of multistage design. The individual stages of the first and second sorting unit form segments that can be distributed between two or more carrying structures, if necessary. According to the invention, the sorting takes place by machine. The above-mentioned second and fourth carrying structures for the sorting unit may thus be designed in each case as a group of at least two carrying structures. The invention does not provide for manual sorting.

The individual units of the device can be fastened in a stable manner to or, alternatively, in a carrying structure by means of releasable or unreleasable connections. If necessary, a single unit may also be fastened on a damping support in a carrying structure, in particular if the respective unit causes vibrations and/or acoustic waves during operation. On account of the described arrangement of a carrying structure on a foundation, a simple supporting structure, or another container, the problem of vibrations, in particular acoustic waves, can continue to be taken into account. If the carrying structure is designed as a container, vibrations caused by sources of sound can advantageously be damped by means of a corresponding sound-insulating coating of the inner walls, floor, and/or ceiling of the container to a greater extent than would be possible in a hall or another building. The device according to the invention can therefore also be set up in an environment in which only limited noise load is permitted. Advantageously, if the carrying structure used according to the invention is designed as a container, it comprises at least one closable opening, e.g. a door, which simplifies maintenance and, if applicable, repair of the unit installed in the special container. In particular, a container used for the control unit, e.g. a prefabricated container, comprises doors. It has also been shown that the individual units with the transport structure do not exceed the permissible weight of a transport vehicle, and therefore a semi-mobile device for carrying out the method according to the invention can be used, in particular if the carrying structure does not exceed the dimensions of a 20-foot or 40-foot container.

According to the invention, the carrying structures with the units arranged therein are not left on the vehicles. Rather, they are set up on a foundation, in particular on point foundations, which can be produced in a fast, simple, and cost-effective manner, but without being permanently connected to the foundation.

If necessary, the carrying structures, supporting structures, and/or containers can be stacked one on top of the other. This design is particularly preferable if, following the flow of material from the material supplied to the wood chips, the outlet of a container through which the material passes first can be arranged above the inlet of a container through which the material subsequently passes. This can typically take place in the case of multi-stage sorting, for example.

It is clear from the description for setting up the carrying structure or, alternatively, container that the device according to the invention for producing wood chips can be set up in a very simple manner without much preparation. Accordingly, the device is easy to dismantle again and can be set up again at another location. It is therefore semi-mobile.

The device according to the invention can easily be supplemented with further units or reduced, depending on the requirements imposed by the wood material used or the requirements for the wood chips to be produced. A building does not have to be erected in order to set up the device according to the invention.

The method according to the invention and/or the device according to the invention can be scaled as desired in terms of output, e.g. in that two or more parallel production lines can be installed for producing wood chips. A typical output of a production line equipped, for example, as per claim 1 or 11 can have a capacity of from 2 t of wood chips per hour to 15 t of wood chips per hour. Here, the chipper has capacities of, for example, at least 6 t per hour, preferably 10 t per hour. The sorting unit may achieve capacities of up to 20 tons per hour, depending on the selected size of the container. In the case of 20-foot containers, the sorting unit can process a capacity of, for example, 10 t per hour, preferably 12 t per hour. Whereas in the case of 40-foot containers, up to 20 t per hour can be sorted. Therefore, it is obvious to adapt the capacities of the sorting unit to the output of the chipper.

The material-carrying lines, which interconnect the carrying structures or the containers and the units arranged therein, such as the material supply unit, first sorting unit, material comminution unit, second sorting unit, and, if applicable, the buffer unit or material separator unit, are preferably modular, i.e. consist, for example, of line sections that are screwed together. In this way, the lines can be adapted to the respective design and/or respective location of the device according to the invention. The material to be comminuted and the wood chips are conveyed in the material-carrying lines e.g. by means of gravity, vibration, as a suction line, or by means of compressed air, in particular in the case of pipelines. If necessary, conveyor belts, trough chain conveyors, or the like may be used as material-carrying lines, wherein the material or the wood chips can then be conveyed on the circulating belts from one of the above-described units to the next one or from one sorting stage to the next. The conveyor belts may be designed so as to be open or closed.

The method according to the invention may be carried out in a continuous or discontinuous manner, wherein continuous method control is preferred. The supply of material to be comminuted to the material supply unit is preferably designed continuously. The device and/or the method according to the invention is suitable for comminuting any wood material. However, the material to be comminuted is preferably recycling wood, in particular untreated or rather uncoated recycling wood, for example from used packaging material such as crates or pallets, which is available in much smaller quantities and in a decentralized manner, i.e. in a different spatial distribution. In addition, it is often large-volume material that is costly or rather cost-intensive to transport. The material to be comminuted is preferably supplied in a size of up to 500 mm, preferably up to 300 mm in the maximum extent. Therefore, if necessary, a first device for reducing the maximum size of the material to be comminuted may be placed upstream of the device according to the invention or the method according to the invention.

The material supply unit of the device according to the invention and/or of the method according to the invention advantageously comprises a receiving container which potentially also consists of the first carrying structure, which may generally be in the form of a container with closed side walls and a floor, or which is inserted in the first carrying structure. The material to be comminuted is fed in via an inlet, advantageously via an open top of the container. Furthermore, the material supply unit comprises a discharge means which supplies the supplied wood material in doses to the subsequent processing units, firstly the first sorting unit. The discharge means may, for example, be designed as a moving floor or as a discharge screw. If necessary, an inclined floor that supplies the wood material received therein to the discharge means is provided in the receiving container. The material to be comminuted is dosed, i.e. supplied in a uniform material flow, by the discharge means to the first sorting unit via the first material-carrying line.

The first sorting unit relates to the sorting of the material to be comminuted. At least one predefined fraction suitable for subsequent material comminution is sorted. Pieces that are too large, and if applicable pieces that are too small, are separated out. In particular, pieces that are too large can be supplied once more to the comminution unit upstream of the material supply unit. If necessary, different fractions of the material to be comminuted can be sorted, which fractions are supplied to different comminution devices in the material comminution unit, for example. The sorting takes place, for example, with the aid of grates, screens, vibrating screens, shakers, or conveyor belts, in each case by means of air classification, e.g. via a suction air or compressed air line and/or by means of vibration, wherein the units of the first sorting are arranged in a second carrying structure and the units of the second sorting are arranged in a fourth carrying structure. In the simplest case, the sorting is carried out in one stage, but preferably in multiple stages. A typical sorting unit comprises, for example, a combination of a vibrating chute and a screen, for example a roller or disk screen. The second sorting unit, which is arranged in at least one fourth carrying structure, follows on from the material comminution unit. It is connected to the material comminution unit via the third material-carrying line and is designed to sort wood chips. In this case, too, shakers, screens, or grates are used. In this case, too, sorting is carried out with the aid of compressed air or vibrations. In this case, too, it is preferable for chips that are too large to be fed back upstream of the material comminution unit in order to prevent waste. According to the invention, the sorting a first time and the sorting a second time take place by machine.

The sorting unit, in particular the first sorting unit, may be supplemented by additional units, in particular by material separator units, e.g. for metal or plastics material. Typical units for separating materials are magnets, X-ray machines, NIR instruments (NIR=near infrared), or gravity separators.

The wood material with the desired dimensions sorted in the first sorting unit as accepted stock is supplied to the material comminution unit by means of the second material-carrying line. The material comminution unit is arranged in the third carrying structure. The material comminution can be carried out using one of the following devices: a striking mechanism, hammer, mill, crusher, or chipper, or using a combination of these devices. The aim is to produce chips, in particular from fragmented wood material. Since recycling wood is preferably to be comminuted, the device for comminution is advantageously designed to comminute dried wood with a moisture content of up to 30 wt. %.

According to further embodiment, the method according to the invention can be carried out using at least one buffer unit which may in each case be arranged upstream or downstream of one of the above-mentioned units (material supply unit, first sorting unit, material comminution unit, second sorting unit). Preferably, a container is used as a buffer unit or a buffer unit that is arranged in a carrying structure. The material to be stored in the buffer unit is supplied via a material-carrying line and an inlet and is supplied to the subsequent unit via an outlet and a material-carrying line or the buffer is used as a storage for finished wood chips.

In very general terms, it should be noted that a carrying structure or, alternatively, container used either as a buffer unit or with a unit arranged therein comprises an inlet and an outlet. Preferably, the inlet and/or outlet are each connected to a material-carrying line or, alternatively, a material-carrying line passes therethrough.

The individual above-mentioned units, which must or rather can be used to carry out the method according to the invention, are each connected to a control unit for the purpose of monitoring and open-loop and/or closed-loop control, which control unit is arranged in a fifth container which may also be a known standard container. The control unit is connected to the individual units via control connections, which are designed either as lines or in wireless form. In addition, the control unit is connected via control connections to sensors, which detect the operating state of the devices and the signals of which are used by the control unit, in particular, for the closed-loop control of the individual units, preferably such that said units are coordinated with one another. Furthermore, the control unit ensures that the wood chips produced meet the predefined requirements, e.g. by adjusting the sorting unit and/or material comminution unit. If necessary, the control unit can also activate or deactivate individual units. According to an advantageous development of the invention, individual units of the device can also be activated without the control unit, e.g. in order to sort a batch of raw material or a batch of chips.

### BRIEF DESCRIPTION OF THE DRAWINGS

In the following, details will be explained in more detail based on an exemplary embodiment. In the figures:

FIG. 1 is a schematic representation of an exemplary embodiment of a device according to the invention;

FIG. 2 is a schematic representation of a material supply unit;

FIG. 3 is a schematic representation of a sorting unit according to a first embodiment;

FIG. 4 is a schematic representation of a sorting unit according to a second embodiment;

FIG. 5 is a schematic representation of a material comminutor;

FIG. 6 is a schematic representation of a buffer unit;

FIG. 7 is a schematic representation of a suction unit;

FIG. 8 is a schematic representation of a carrying structure.

### DETAILED DESCRIPTION

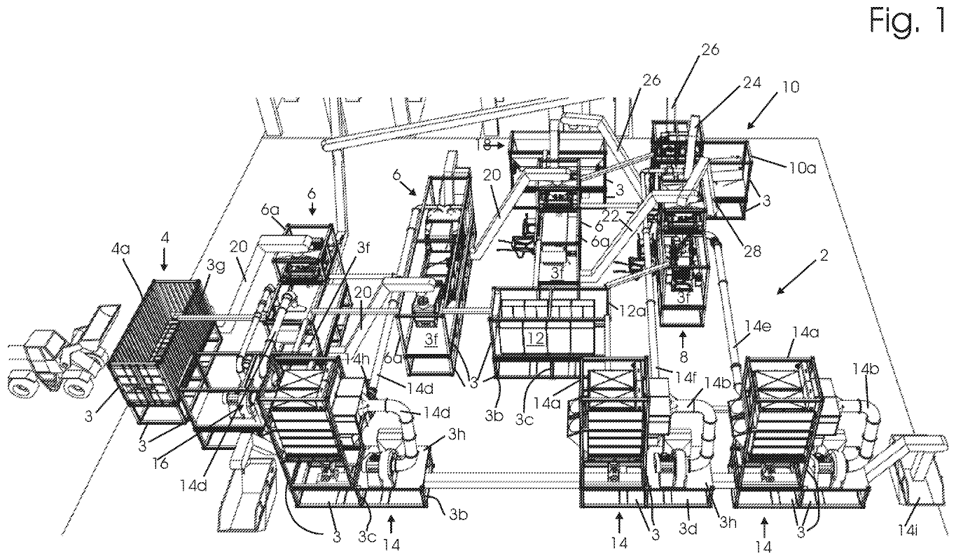

According to FIG. 1, a device 2 according to the invention for producing wood chips comprises, as units of the device 2, a material supply unit 4, a first sorting unit 6, a material comminution unit 8, a second sorting unit 10, a control unit 12, and, as optional units, a suction unit 14, a material separator unit 16, and a buffer unit 18. All of the above-mentioned units 4 to 18 are each arranged in a carrying structure 3 that may also be designed as a container, i.e. with a floor, walls, or a ceiling at least in sections.

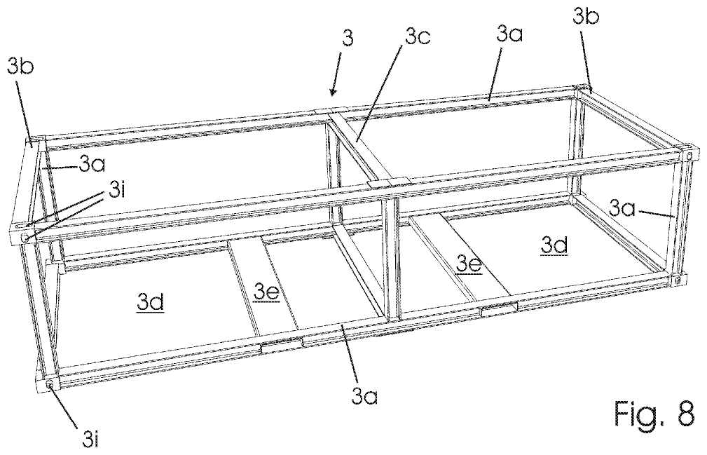

FIG. 8 shows a carrying structure 3 that is prepared for receiving a unit of the device according to the invention. The carrying structure 3 is constructed from beams 3a, in this case double T-beams made of steel that are releasably or unreleasably interconnected, e.g. welded together. Moreover, it is preferable, as shown in FIG. 8, for two outer closed frames 3b consisting of interconnected beams 3a to be arranged at each end of the carrying structure 3. Preferably, an additional closed frame 3c is also arranged, which usually provides additional stability to the carrying structure 3 in a mostly central arrangement. In the embodiment according to FIG. 8, between each outer closed frame 3b and the central closed frame 3c, a steel profile 3e is inserted in sections in the floor of the carrying structure 3 between the two outer double T-beams 3a. In the present case, the steel profile 3e consists of two steel plates which are interconnected with a spacing and to which or, alternatively, on which the respective unit is fastened. In general, steel profiles 3e or steel plates of this kind can be attached in sections in the walls, ceiling, or floor of the carrying structure, as needed, in order to be able to optimally fasten or rather secure the respective unit to be received in the carrying structure 3. Optionally, further components, e.g. for sound or vibration damping, can be attached between the steel profile 3e or steel plate or the double T-beams of the carrying structure 3 and the unit to be fastened.

The beams 3a of the carrying structure 3 span a space whose base area 3d is freely selected, but which is preferably rectangular and, for example, corresponds to the dimensions of a 20-foot shipping container. The height of the carrying structure can also be freely selected, but is preferably adapted such that the carrying structure 3 is transportable. The height of the carrying structure is preferably such that transportation, for example by truck or train, is possible. If the carrying structure 3 receives a unit according to the invention, the height of the carrying structure is preferably limited to the height of a 20-foot shipping container. The height of the carrying structure 3 may also be lower than in a 20-foot shipping container if it does not receive a unit according to the invention, but rather is designed as a simple carrier or rather supporting structure that is intended such that a carrying structure 3 receiving a unit is to be placed onto the simple carrier or rather support structure.

As shown in FIG. 1 to 7, in this exemplary embodiment, the carrying structure 3 is generally designed as a container, and therefore comprises a floor 3f and side walls 3g, and, if applicable, a ceiling 3h at least in sections, e.g. in order to prevent soiling of the units or for sound insulation purposes. Means 3i for fastening the carrying structure 3 are preferably attached to the beams 3a of the carrying structure 3 and/or to the side walls 3g, preferably to or, alternatively, on a further simple carrier or rather supporting structure 3 or another container or to a vehicle. The means 3i for fastening are known per se, for example from shipping containers. They are preferably cutouts in which releasable fastening means can engage. Likewise, handling means (crane hooks, lugs, etc.) can engage with the means 3i for fastening, such that the carrying structure 3 can be handled, e.g. raised, positioned, or moved. The carrying structure 3 is preferably designed in each case for transportation by truck or train. The carrying structure 3, in particular in the design as a container, may comprise doors 3j, e.g. preferably in the narrow sides of the generally rectangular carrying structure or container, in order to facilitate maintenance and, if applicable, repair of the units installed in the carrying structure 3.

The device according to the invention is characterized by a particularly simple design which is suitable for mobile or semi-mobile use. The units can be arranged in any form of container, but containers which can be transported on trucks or trains are preferred.

In the embodiment shown in FIG. 1, some of the units of the device are partly arranged in a container or, alternatively, designed as containers, i.e. as a carrying structure 3 that is provided at least in parts with a floor 3f, walls 3g, and/or a ceiling 3h, wherein the container with the unit contained therein is in each case placed on a simple carrier or rather supporting structure 3 made of metal in the embodiment according to FIG. 1. The carrying structure 3 has the same length and width as a 20-foot shipping container, for example, whereas the height of the carrying structure 3 is individually adapted in each case. Accordingly, the carrying structure 3 may also be transported and set up in the manner of a known shipping container, in particular if the carrying structure 3 has the same receptacles 3i for fastening means as a known container.

The carrying structure 3 containing a unit or, alternatively, the container is fastened to the simple carrier or rather supporting structure 3 using a fastening means, in this case screwed bolts. Said fastening means is either a known fastening means by means of which the container is also fastened, for example, to a truck or on a railway carriage. Alternatively plug-in connections, for example, may be formed, wherein a plug-in element is aligned with a receptacle 3i on the container and with a receptacle 3i on the supporting structure 3 and passes through said receptacles 3i. On account of the receptacles 3i, in addition to a plug-in connection, a screw connection or another, preferably releasable connection, can be established between the container and the supporting structure 3. However, a form-fitting connection can also be used to fasten a container on a supporting structure 3, advantageously in conjunction with an additional plug-in connection that prevents the container from becoming released from the supporting structure 3. The advantage of the combination of a simple carrier or rather supporting structure 3 and a carrying structure 3 containing a unit is that the various units are each arranged at the optimal height relative to one another. The simple supporting structure and also the carrying structure 3 containing a unit can in each case be reused at different locations. It can also be transported on trucks or trains.

Alternatively, the simple supporting structure 3 or the carrying structure 3 containing a unit or, alternatively, the container is placed on a foundation, wherein a point foundation for approx. four to six contact points on which the carrying structure 3 then rests is usually suitable. According to a third embodiment, a simple supporting structure or a carrying structure 3 containing a unit or rather a container can also be stacked one next to the other or one on top of the other. In this third embodiment, too, supporting and/or carrying structures 3 and/or containers arranged one next to the other or one above the other are secured to one another, wherein the above-described fastening means can be used. The three alternatives for the arrangement of supporting and/or carrying structures 3 and/or containers can also be combined when setting up a device for producing wood chips with multiple units.

The individual units are in each case releasably or unreleasably fastened to the carrying structure 3 and, if applicable, in a container, for example by means of screws, plug-in connections, rivets, welded connections, or latching connections, but also by means of form-fitting connections. If necessary, the individual units are each mounted on sound-damping or vibration-damping supports. The carrying structure provides beams 3a, steel profiles 3e, and/or steel plates that are in each case individually adapted to the units and that take into account the size, weight, and weight distribution of the respective unit. According to further embodiment, a container is provided with a sound-damping coating on the inner wall.

Furthermore, the lines, in particular the material-carrying lines, are mounted on sound-damping and/or vibration-damping supports, if necessary. If a line is designed as a closed line, i.e. provided with a housing, said line can also be provided with a sound-damping coating at least in sections on the inner wall.

In the following, units of the device 2 according to the invention are presented in alternative embodiments as well. The same components are given the same reference signs in connection with this description. The individual units of the material supply unit 4, the first and second sorting unit 6, 10, and the material comminution unit 8, as well as, if applicable, the suction unit 14, the material separator unit 16, and the buffer unit 18 are either known units or are provided in the desired dimensions within the scope of customary adaptations.

The device 2 is designed for producing wood chips, e.g. for producing wood-based materials, for example, such as chipboards, or for producing fibers for fiberboards, in particular MDF boards, or insulating materials. According to the exemplary embodiment, it is designed for processing wood material having a length of at most 500 mm, preferably at most 300 mm. The wood material either comes from fresh wood or, preferably, from recycling wood, e.g. from roughly broken-up pallets or crates.

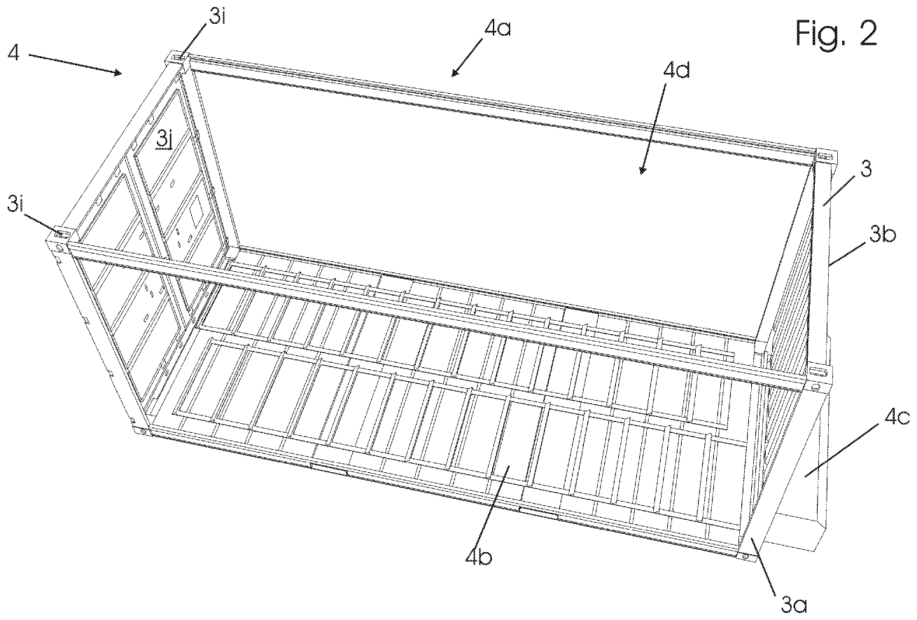

The material supply unit 4 comprises a carrying structure 3, which is equipped with a moving floor 4b and walls 3g as a first container 4a, as shown in detail in FIG. 2. The moving floor 4b as the discharge device supplies the wood material on the floor of the first container 4a to a first material-carrying line 20, which connects the material supply unit 4 to a first sorting unit 6. The first material-carrying line 20 is equipped with a conveyor belt or a trough chain conveyor for transporting the material to be comminuted. It starts at the lower end at the outlet 4c of the first container 4a and ends at the top of the second container 6a of the first sorting unit 6. As shown in FIG. 2, the material to be comminuted is supplied to the material supply unit 4 via an inlet 4d, in this case the open top of the first container 4a. The material supply unit 4 is arranged on a simple carrier or rather supporting structure 3 which has the same dimensions as the material supply unit 4.

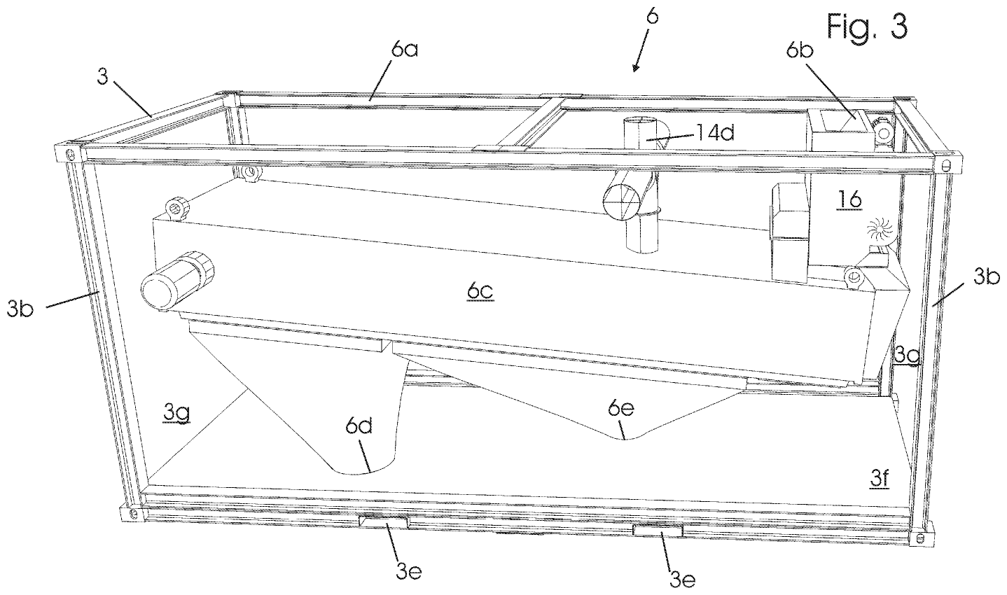

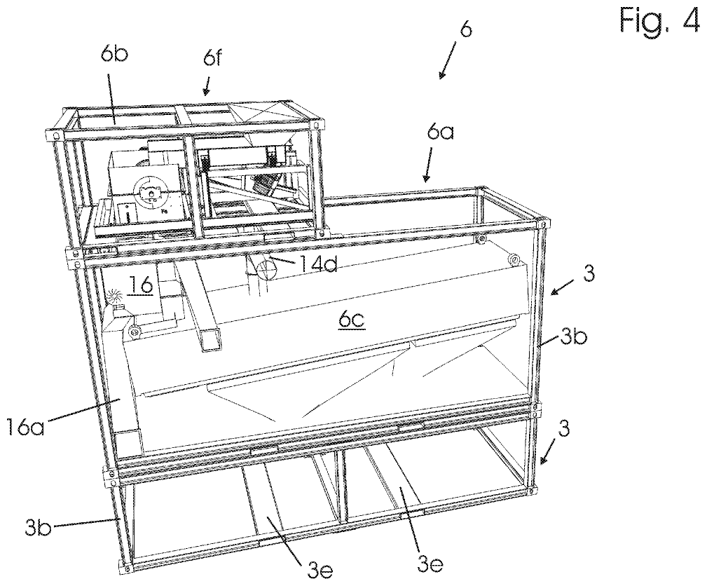

The first sorting unit 6 sorts the wood material to be comminuted. The first sorting unit 6 is three-stage. All carrying structures 3 that have sorting units are in each case placed on a simple carrier or rather supporting structure 3 which has the same dimensions as the carrying structures of the first sorting unit 6 placed thereon. The carrying structures 3 of the first sorting unit 6 are in each case designed as a second container 6a, which has a floor 3f. In each case one of the three carrying structures 3 depicted in FIG. 3 or 4 and pertaining to a first sorting unit 6 may be designed for splitting the wood material to be comminuted into at least two fractions. According to FIG. 3, the material to be comminuted is supplied, for example, through an inlet 6b into which the first material-carrying line 20 opens. FIG. 3 shows a first sorting unit 6, which is designed as a screen 6c and is placed in the second container 6a. The first material-carrying line 20 opens out through the inlet 6b in the top or in a side wall in the second container 6a. The screen 6c separates the material to be comminuted into two fractions, for example a first fraction of wood material up to 20 mm in length in the largest dimension and a second fraction of wood material of more than 20 mm in length in the largest dimension. The first fraction is processed further as accepted stock and, for example, is used to produce chipboards or fiberboards, whereas the second fraction is too large to be processed as accepted stock and is supplied to the material comminution unit. Particles that are too small are discharged. Accordingly, FIG. 3 shows a first outlet 6d and a second outlet 6e for the screen 6c. The outlets open out in the floor of the container 6a, alternatively, depending on the configuration of the sorting unit, the outlets may also be arranged in the side walls or in the top of the second container 6a. According to the embodiment according to FIG. 1, in order to adapt the output of the first sorting unit 6 to the output of the material supply unit 4 and material comminution unit 8, second containers 6a each having at least one unit of the first sorting unit 6 are arranged in series. The three carrying structures 3 of the first sorting unit 6 are in each case interconnected by means of material-carrying lines 20. Material that is too large is in each case conveyed further to the next unit of the first sorting unit 6, where it is sorted again. Preferably, each second container 6a comprises another unit for sorting or alternatively, another combination of units, e.g. according to FIG. 3 or FIG. 4.

In the present case, the first sorting unit 6 is connected via a suction line 14c to a suction unit 14, which is designed as explained in more detail below. The suction line 14c may be connected via any side of a second container 6a.

As an alternative to the embodiment of the first sorting unit according to FIG. 3, according to FIG. 4, the material to be comminuted may be sorted by means of a vibrating chute 6f which distributes the material to be sorted over a wide area, followed, for example, by a roller or disk screen. Said vibrating chute 6f is arranged above the second container 6a in its own carrying structure 3, the width of which coincides with the width of the second container 6a. In this embodiment, the first material-carrying line 20 for the material to be comminuted is guided through an inlet in the top of the carrying structure 3 of the vibrating chute 6f. In this embodiment, the second container 6a is specially adapted to the requirements of the roller or disk screen arranged therein. The outlet or rather the outlets of the roller or disk screen are in this case arranged in the floor 3f of the second container 6a, which rests on a simple carrier or rather supporting structure 3. The roller or disk screen in the second container 6a is connected via a suction line 14c to the suction unit 14, which ensures that no wood dust escapes from the first sorting unit 6. A material separator unit 16 is arranged between the vibrating chute 6f and the second container 6a, said material separator unit 16 is designed with a gravity separator, X-ray machine, or NIR instrument, for example in order to remove foreign bodies. Foreign bodies are then discharged via a line 16a. More details on the material separator unit 16 are provided below.

As shown in FIG. 1, according to a first alternative, the flow of the material to be comminuted can pass through two or more containers of the first sorting unit 6 one after the other by means of material-carrying lines 20. According to a second alternative not shown here, the flow of the material to be comminuted is divided into sub-flows, the number of which corresponds to the number of carrying structures 3 or containers of the first sorting unit 6, if the two or more second containers 6a of the first sorting unit 6 are arranged in parallel.

In the embodiment according to FIG. 1, the material separator unit 16 is connected to the sorting unit 6. The material separator unit 16 is usually arranged in a container 6a, 10a of the first or second sorting unit or in its own carrying structure 3 in connection with the first or second sorting unit 6, 10. The material separator unit 16 usually comprises one of two units, either a first unit designed to separate metal particles or particles from the accepted stock of the first sorting unit that are heavier than the wood material (gravity separator). The second unit generally used in later stages of the sorting process is designed to separate foreign matter or particles that are, for example, lighter than the wood material, e.g. plastics particles and/or plastics films. In this case, X-ray machines or devices that detect foreign matter by means of near infrared (NIR) can be used, for example.

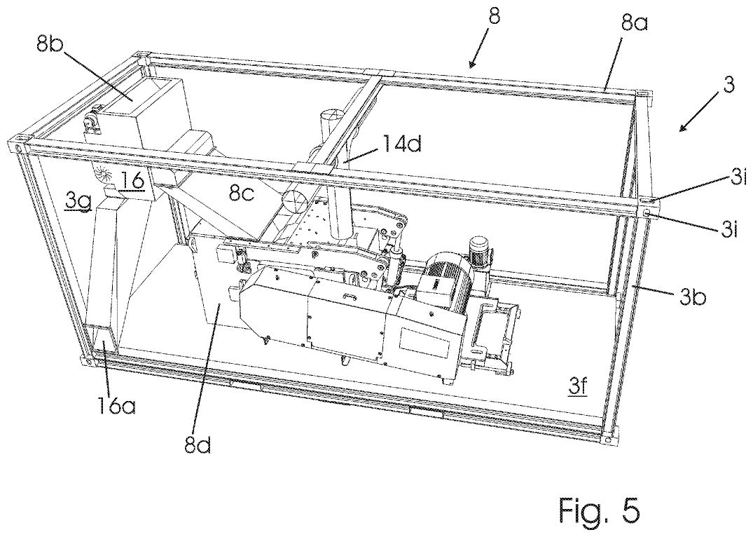

According to FIG. 1, a second material-carrying line 22 connects the second container 6a of the first sorting unit 6 to the material comminution unit 8, which is arranged in a carrying structure in a third container 8a, as shown in detail by way of example in FIG. 5. The container 8a rests on a simple carrier or rather supporting structure 3. A material separator unit 16 is arranged in the third container 8a upstream of the unit for material comminution. The second material-carrying line 22 is connected to the material separator unit 16, e.g. an X-ray machine or NIR instrument, through an inlet 8b in the top of the third container 8a. The inlet 8b can be made in any desired wall of the container depending on the arrangement of the third container 8a. A connection 8c leads from the material separator unit 16 to the unit that comminutes the material. A striking mechanism, a hammer, a mill, a crusher, or a chipper, for example, can be installed in the third container 8a as the unit for material comminution, depending on the material to be comminuted and the requirement on the comminuted material. In the present embodiment according to FIG. 1, said unit is a chipper 8d, which is designed to produce wood chips. In the case of the material comminution unit 8, too, two or more of the above-mentioned units can be combined so as to be arranged either in parallel or one after the other. A combination of a crusher and a chipper arranged downstream thereof, through which the material to be comminuted passes one after the other, is particularly suitable, for example. If the output of the device 2 is to be increased, multiple third containers 8a can also be arranged in parallel in this case too. The material comminution unit 8 is connected to a second sorting unit 10 arranged in a fourth carrying structure 10a via an outlet connected to a third material-carrying line 24. The third material-carrying line 24 extends from the bottom of the third container 8a to the top or to a side wall 3g of the fourth container 10a. According to FIG. 1, the material comminution unit 8 is also connected to the suction unit 14 via a suction line 14d.

The third material-carrying line 24 may be designed as a conveyor belt, trough chain conveyor, or as a blow line in which wood chips are conveyed to the second sorting unit 10 by means of compressed air, for example.

The fourth container 10a, which is designed, for example, as a carrying structure 3 clad with a floor, walls, and a ceiling, comprises the second sorting unit 10, which is designed to fractionate chips. In this case, too, as described above in connection with the first sorting unit 6, a single-stage or multi-stage sorting can be provided and two or more second sorting units 10 may be arranged in parallel in order to adapt the capacity and, if necessary, each of the units arranged in parallel may be arranged in their own container. One or more shakers, screens, or vibrating chutes may be provided in each case for the second sorting unit 10, as already described above with respect to the first sorting unit 6. The second sorting 10 can also take place by means of compressed air, gravity, or vibration, for example. As shown in FIGS. 3 and 4, the second sorting unit 10 is preferably also connected via a suction line 14e to the suction unit 14, which vacuums the dust produced in the second sorting unit 10. While a fraction that is too small is either extracted as dust or separated out, a fraction that is too large is preferably supplied to the material comminution unit 8 again via a fifth material-carrying line 28 in order to reduce waste and to maximize the yield. The accepted stock of the second sorting unit also passes through a material separator unit 16 arranged in or on the fourth container 10a so as to produce accepted stock that has no disruptive foreign matter.

A fourth material-carrying line 26 leads from the second sorting 10 to utilization of the wood chips produced, in particular to wood-based material production, but also to insulating material production or to other methods of further processing. The fourth material-carrying line 26 may be designed in the same way as the third material-carrying line 24.

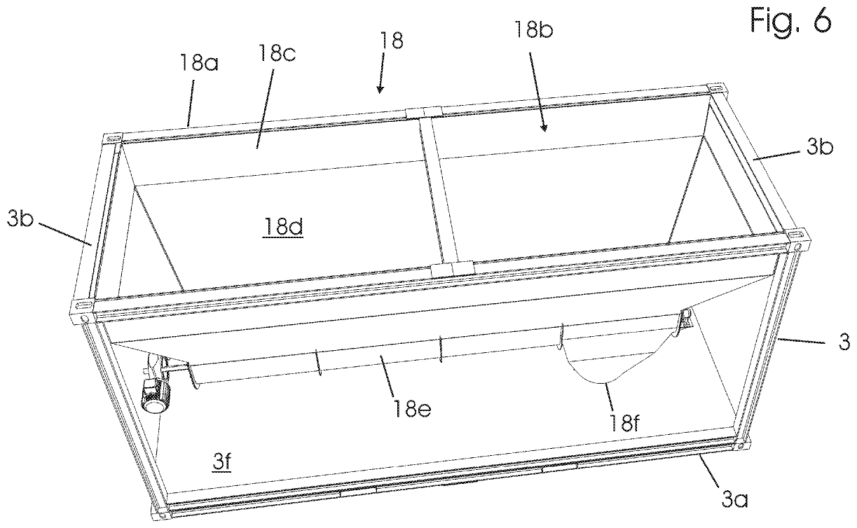

In order to constantly provide subsequent production with the desired amount of wood chips, according to the embodiment of FIG. 1, a buffer unit 18 is inserted in the fourth material-carrying line 26. The buffer unit 18 is optionally and can be arranged upstream or downstream of the material supply unit 4, the first or second sorting unit 6, 10, or upstream of the material comminution unit 8, depending on the requirements of the respective embodiment of the device 2 according to the invention. According to FIG. 6, the buffer unit 18 is designed as a carrying structure 3 in which a container 18a having an inlet 18b designed as the open top 18c of the container 18a is inserted. The walls 18d of the container 18a taper in the manner of a funnel toward a screw conveyor which is arranged in a trough 18e at the lower end of the walls 18d and which conveys the wood chips stored in the buffer unit 18 to an outlet 18f. The outlet 18f is connected to the fourth material-carrying line 26.

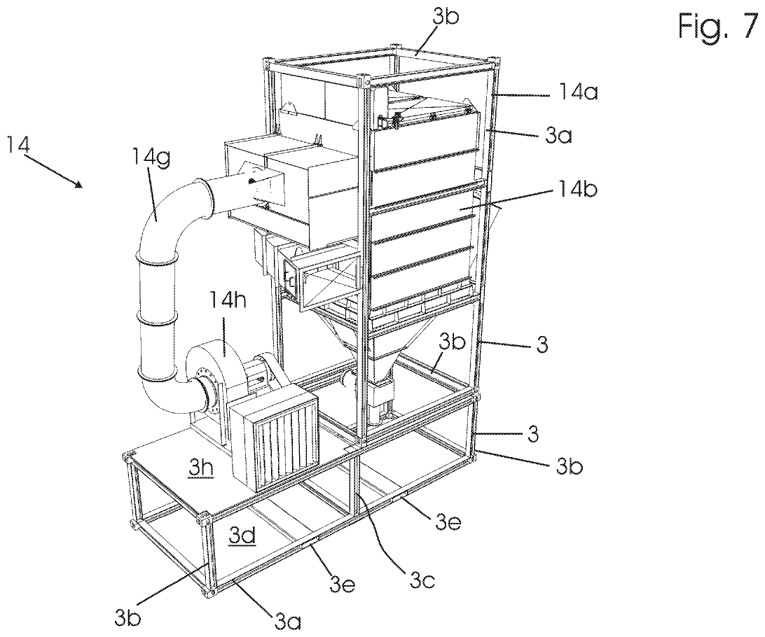

FIG. 7 generally shows a suction unit 14b which is arranged substantially within a carrying structure 3 designed as a container 14a and which forms the suction unit 14 together with the suction lines 14c-f, among other things. The suction unit 14 is arranged in a cuboid carrying structure 3 that is standing on an end face. However, the drive 14g and the suction pipe 14h are arranged outside the container 14a. They are attached on one half of a simple carrier or rather supporting structure 3, on the other half of which the container 14 rests by the end face thereof. The suction pipe 14h and the drive 14g are transported separately from the container 14a during transportation. If necessary, as shown in FIG. 1, multiple suction units 14b may be arranged in parallel. Suction units 14b arranged in parallel may have different output or be designed to extract particles of different weights or sizes. In the embodiment according to FIG. 1, three suction units 14 are provided.

The suction unit 14b generates a negative pressure in the suction lines 14c-f, through which dust and other lightweight particles are drawn in the direction of the suction unit 14b, where they are separated off by means of a pocket filter. A suction line 14c connects the material supply unit 4 to the suction unit 14b, a suction line 14d connects the first sorting unit 6 to the suction unit 14b, a suction line 14e connects the material comminution unit 8 to the suction unit 14b, and a suction line 14f connects each stage of the two-stage second sorting unit 10 to the suction unit 14b. The material supplied to the suction unit 14 by means of the suction lines 14c-f is collected in a waste container 14i.

According to the embodiment according to FIG. 1, all above-mentioned units of the device 2 are monitored, controlled in an open-loop manner and, if applicable, in a closed-loop manner by means of the control unit 12 arranged in the fifth container 12a. The fifth container 12a may consist of a typical 20-foot shipping container, but it may also be composed of a carrying structure 3 clad at least in sections with a floor, walls, and a ceiling. In order to ensure easy access to the control unit 12, the fifth container 12a comprises a door in a side wall. The monitoring of the device according to the invention takes place by means of sensors (not shown here) which, for example, detect the material flow or block-ages in the material flow or which, for example, detect the fill level of the material supply unit 4 or buffer unit 18 or which detect the power consumption of the first or second sorting unit 6, 10 or of the material comminution unit 8 or of the suction unit 14 or of the material-carrying lines 20, 22, 24, 26, 28. Sensors may also detect the proportion of fractions of wood chips produced by means of the material comminution unit 8 or the proportion of waste produced. The sensors send corresponding signals to the control unit 12, which then checks whether the signals are within the predefined tolerances or whether closed-loop control of individual or multiple units of the device 2 is required. The closed-loop control takes place via control connections either wirelessly or by means of lines. However, the control unit 12 may also control individual units if this is desired.

The method according to the invention is carried out in that uncomminuted material made of wood, either unprocessed wood or already processed wood that is to be recycled, i.e. so-called recycling wood, is supplied to a device 2 for producing wood chips. The uncomminuted material has preferably already been broken up, e.g. into pieces having a length of at most 500 mm, in particular at most 300 mm. This material, which is still uncomminuted within the context of the invention, is fed to the material supply unit 4. There, if applicable, the material is freed as far as possible of particles that are too heavy or too light or of other foreign matter, in particular metal parts such as nails or staples and plastics materials, e.g. plastics films adhering to the wood. The material to be comminuted is then supplied to the first sorting unit 6, which as a single-stage or multi-stage sorting separates out material that is too small and material that is too large. The material that is too large is preferably broken up again and is then supplied to the material supply unit 4 again. The material that is too small can potentially be used further directly without further material comminution. The uncomminuted material of a suitable size sorted in the first sorting unit 6 is then supplied to the material comminution unit 8 after it has passed through a further material separator unit if necessary. In the material comminution unit, the uncomminuted material is comminuted in one or more stages into the desired wood chips. The material comminution unit 8 is followed by the second sorting unit 10, which sorts the comminuted material in one or more stages. Here, too, material that is too fine or too coarse is separated out and, if applicable, the material passes through a material separator unit again. The material that is too large is preferably supplied to the material comminution unit 8 again. The comminuted material in the desired or rather predefined size is supplied for further processing.

The method according to the invention provides that the steps of supplying material, sorting the uncomminuted material, comminuting material, and sorting the comminuted material are monitored and controlled in an open-loop and, if applicable, closed-loop manner by a control unit 12.

Optionally, according to the method according to the invention, at least one suction unit 14 is provided, which collects dust and other small and lightweight particles via suction lines 14c-f. Also optionally, at least one material separator unit 16 may be provided, e.g. for separating heavy, magnetic, or lightweight particles and/or other foreign matter, e.g. metal or plastics material.

Finally, the method according to the invention may provide at least one buffer unit 18, which can be assigned to one of the above-described units 4, 6, 8, or 10 and which makes it possible to store the material to be comminuted or the comminuted material.

The method according to the invention for producing wood chips may, for example, provide a capacity of from 2 t of wood chips per hour to 15 t of wood chips per hour. The chipper may, for example, have capacities of at least 6 t per hour, preferably 10 t per hours, whereas the sorting unit may achieve capacities of up to 20 tons per hour, however this depends on the selected size of the container. In the case of 20-foot containers, the sorting unit can process a capacity of, for example, 10 t per hour, preferably 12 t per hour, whereas in the case of 40-foot containers, up to 20 t per hour can be sorted, for example. This quantity may be of economic interest, for example, for operating a pilot plant or test facility or for providing a sub-flow of comminuted material for the production of wood-based materials or insulating materials, for example a sub-flow of wood chips made from recycling wood for common processing into fiberboards or chipboards together with chips of unprocessed wood. The method according to the invention may be carried out with a device belonging to a production apparatus. However, the device for carrying out the method may also be set up independently of a production device.

List of reference signs

| | |
|---|---|
| 2 | Device |
| 3 | Carrying structure |
| 3a | Beam |
| 3b | Outer closed frame |
| 3c | Central closed frame |
| 3d | base area |
| 3e | Steel profile |
| 3f | Floor |
| 3g | Wall |
| 3h | Ceiling |
| 3i | Cutout |
| 3j | Door |
| 4 | Material supply unit |
| 4a | First container |
| 4b | Moving floor |
| 4c | Outlet |
| 4d | Inlet |
| 6 | First sorting unit |
| 6a | Second container |
| 6b | Inlet |
| 6c | Screen |
| 6d | First outlet |
| 6e | Second outlet |
| 6f | Vibrating chute |
| 8 | Material comminution unit |
| 8a | Third container |
| 8b | Inlet |
| 8c | Line |
| 8d | Chipper |
| 10 | Second sorting unit |
| 10a | Fourth container |
| 12 | Control unit |
| 12a | Fifth container |
| 14 | Suction unit |
| 14a | Container |
| 14b | Suction unit |
| 14c-f | Suction lines |
| 14g | Suction pipe |
| 14h | Drive |
| 14i | Waste container |
| 16 | Material separator unit |
| 16a | Line |
| 18 | Buffer unit |
| 18a | Container |
| 18b | Inlet |
| 18c | Open top of container |
| 18d | Walls |
| 18e | Trough |
| 18f | Outlet |
| 20 | First material-carrying line |
| 22 | Second material-carrying line |
| 24 | Third material-carrying line |
| 26 | Fourth material-carrying line |
| 28 | Fifth material-carrying line |

1. A method for producing wood chips for the production of chipboards, comprising
a material supply unit (4) in at least one first carrying structure (3, 4a) that is adapted to the material supply unit (4),
a first mechanical sorting unit (6), the material to be comminuted a first time in at least one second carrying structure (3, 6a) that is adapted to the first sorting unit (6),
a material comminution unit (8) in at least one third carrying structure (3, 8a) that is adapted to the material comminution unit (8),
a second mechanical sorting unit (10), the comminuted material to be comminuted a second time in at least one fourth carrying structure (3, 10a) that is adapted to the second sorting unit (10),
wherein the first, second, third, and fourth carrying structures (3, 4a, 6a, 8a, 10a) are each arranged so as to be semi-mobile on a foundation and/or on a supporting structure and are interconnected either directly or via material-carrying lines (20, 22, 24, 26), wherein the supplied material is conveyed from the material supply unit (4) through a first material-carrying line (20) to the first mechanical sorting unit (6) and is sorted, and is supplied from the first mechanical sorting unit (6) through a second material-carrying line (22) to the material comminution unit (8) and is comminuted therein so as to form wood chips, and is supplied from there through a third material-carrying line (24) to the second mechanical sorting unit (10), in which the wood chips are sorted by machine, whereupon the wood chips are provided for the production of chipboards.

2. The method according to claim 1, wherein a container (4a, 6a, 8a, 10a, 12a, 14a, 16a, 18a) is used as the carrying structure (3), wherein the carrying structure is covered at least in sections by a wall which forms a floor, wall, or ceiling of the container.

3. The method according to claim 1, wherein the foundation is supported in a sound-insulated and/or vibration-insulated manner.

4. The method according to claim 1, wherein the material supply unit (4) arranged in at least one carrying structure (3) comprises a container (4a) or receiving container to which material is fed continuously or discontinuously as well as an outlet (4c), wherein the outlet (4c) is designed as a moving floor (4b) or discharge screw.

5. The method according to claim 1, wherein the first and/or second sorting (6, 10) takes place in each case in one or multiple stages.

6. The method according to claim 1, wherein the sorting (6, 10) takes place by means of shakers or a vibrating chute and/or at least one screen (6c), and/or at least one material separator unit (16) separates off foreign matter.

7. The method according to claim 1, wherein the material comminution (8) takes place by means of one or more device selected from the group consisting of a striking mechanism, hammer, mill, crusher, and chipper.

8. The method according to claim 1, wherein the capacity of the chipper is at least 6 to at most 10 t per hour, and the capacity of the sorting unit (6, 10) is at least 8 to at most 20 t per hour.

9. The method according to claim 1, wherein at least one buffer unit (18) for raw material and/or wood chips is provided in at least one fifth carrying structure (3, 18a).

10. The method according to claim 1, wherein fastening and carrier devices are fitted on the carrying structure (3, 4a, 6a, 8a, 10a, 12a, 14a, 16a, 18a).

11. The method according to claim 1, wherein the material supply unit (4), sorting unit (6), material comminution unit (8), and material-carrying lines (20, 22, 24, 26) as well as, optionally, the suction unit (14), material separator unit (16), or buffer unit (18) are monitored, controlled in an open-loop and/or closed-loop manner by means of a control unit (12), wherein the control unit (12) is arranged in a container (12a) and is connected by control lines to the material supply unit (4), first sorting unit (6), material comminution unit (8), and second sorting unit (10) as well as, optionally, to the suction unit (14), material separator unit (16), or buffer unit (18).

12. A device (2) for producing wood chips for the production of chipboards, comprising
at least one first carrying structure (3, 4a) that is designed to receive a material supply unit (4),
at least one second carrying structure (3, 6a) that is designed to receive a first mechanical sorting unit (6) for the material to be comminuted,
at least one third carrying structure (3, 8a) that is designed to receive a material comminution unit (8),
at least one fourth carrying structure (3, 10a) that is designed to receive a second mechanical sorting unit for wood chips,
at least one control unit (12) at least for the material supply unit (4), the first mechanical sorting unit (6), the material comminution unit (8), and the second mechanical sorting unit (10),
wherein the first, second, third, and fourth carrying structure (3, 4a, 6a, 8a) are set up in a semi-mobile manner on a foundation and/or supporting structure and interconnected by means of material-carrying lines (20, 22), wherein the first, second, third, and fourth carrying structure (3) is designed as a container (4a, 6a, 8a, 10a), wherein the carrying structure is covered at least in sections by a wall which forms a floor, wall, or ceiling of the container.

13. The device according to claim 12, wherein at least one buffer unit (18) is arranged in at least one fifth carrying structure (3, 18a).

14. The device according to claim 12, wherein the foundation is supported in a sound-insulated and/or vibration-insulated manner.

15. The device according to claim 12, wherein fastening and carrier devices are formed on the carrying structure (3, 4a, 6a, 8a, 10a, 12a, 14a, 16a, 18a).

16. The device according to claim 12, wherein the carrying structure (3, 4a, 6a, 8a, 10a) comprises an inlet (4d, 6b, 8b) for a material-carrying line which supplies material and comprises an outlet for a material-carrying line that discharges material, wherein a material supply unit (4), a sorting unit (6), a material comminution unit (8), a material separator unit (16), or a buffer unit (18) is arranged in the carrying structure (4a, 6a, 8a, 10a).

17. The method according to claim 1, wherein the chipboards are made from recycling wood.

18. The method according to claim 6, wherein the foreign matter is metal and/or plastics material.

19. The method according to claim 8, wherein the capacity of the chipper is 8 to 10 t per hour.

20. The method according to claim 10, wherein the fastening and carrier devices comprise screw or plug-in or form-fitting connections.
